(19) United States
(12) Patent Application Publication
(10) Pub. No.: US 2023/0255254 A1
(43) Pub. Date: Aug. 17, 2023

(54) RETRACTABLE GUIDE

(71) Applicant: PLANT MEAT LTD, London (GB)

(72) Inventor: Peter SHARMAN, London (GB)

(21) Appl. No.: 18/012,250

(22) PCT Filed: Jun. 25, 2021
(86) PCT No.: PCT/GB2021/051619

§ 371 Date: Dec. 22, 2022

(30) Foreign Application Priority Data
Jun. 25, 2020 (GB) 2009693.9

(51) Int. Cl. A23P 30/20; A23J 3/26; B29C 48/00; B29C 48/25; B29C 48/885; B29C 48/88

(52) U.S. Cl. CPC A23P 30/20; A23J 3/26; B29C 48/022; B29C 48/25686; B29C 48/885; B29C 48/911; A23J 3/227

(57) ABSTRACT

A retractable guide (200) is provided for use in a cooling die (202) for the manufacture of extruded food products. The retractable guide (200) is configured to be secured between an input end and an output end of the cooling die (202). A method of high moisture extrusion suitable for manufacturing foodstuffs is also provided, which comprises inserting the retractable guide (200) into a cooling die (202).

### FIELD OF THE INVENTION

The present invention relates to a food product and process. In particular, the invention is designed for use in producing a meat alternative product by using an extrusion process. It is for example applicable to vegetarian or vegan analogues to meat or fish.

In particular, the present invention relates to a retractable guide for use in a cooling die in the manufacture of an extruded food product. The retractable guide is attachable to the cooling die such that it may be inserted and removed from the cooling die as required. .

### BACKGROUND

Veganism and vegetarianism are increasingly common lifestyle choices around the globe, particularly in the UK and USA. Veganism is defined as not consuming dairy, meat, fish or egg products. This means that their diet must consist of plant based food products that maintain the highest sources of nutrients. Vegetarianism is defined as the practice of not eating meat or fish. As a result of this change in eating habits among the general population there is an increased demand for meat free protein products and meat alternatives.

One method used to generate meat alternative products is through high moisture extrusion apparatus. High moisture extrusion cooking of plant or vegetable proteins (e.g. soy) has recently started being used to produce meat analogues. High moisture extrusion cooking is a process that allows the formation of a strand or larger pieces from protein rich powders, slurries or small pieces such as plant proteins or meat and fish substitutes. Typically plant proteins are mixed with water in an extruder barrel and the combination of heating and subsequent cooling of the mixture facilitates the texturization and creation process to produce a layered or fibrous structure with a ‘meat-like’ appearance. There are several variables in the process of high moisture extrusion that can affect the end product. Raw material characteristics from various sources (wheat, soya, pea, chickpea, faba bean, lupine or other grain legumes and oilseeds such as rapeseed, sunflower, linseed and others) and from various manufacturing, protein purification and drying procedures (flours, press cakes, protein extracts, concentrates or isolates; defatted and/or dried products as well as slurries). Further the extruder and process design dictate the formation of fibrous structures like that of meat. Additionally, system parameters such as throughput, pressure, water content and temperature profile must also be considered.

There are also known multi-channel (or duct) cooling dies where the extrudate exiting the extruder is ‘split’ and made to flow into a number of individual cooling ducts disposed about a longitudinal axis of the die such that individual strands of solidified, textured product are delivered at the cooling die outlet. However, these multi-channel cooling dies are typically fixed in configuration and cannot be altered to due to the cooling ducts used to transmit coolant. As technology improves and new die designs are brought to market, there is a significant problem when trying to scale or move over, from one cooling die onto another.

A key factor which impacts the product quality (specifically fibre formation) are ‘edge effects’ — that is, as the product passes through the cooling die the shear effects caused by the walls of the cooling die will have a marked impact on the end product. Generally speaking, areas furthest from the ‘edges’ of the die experience lesser fibre formation, which can be useful for some application, but in general is undesirable.

The present invention seeks to address these, and other, disadvantages encountered in the prior art by providing an improved cooling die and retractable guide for insertion into a cooling die. The purpose of this innovation is to create a simple, but effective way to be able to guide the flow of material through a cooling die, without needing to fundamentally or permanently alter it. This optimization can be conducted in a much shorter time span than it would take to weld various channels for instance. Instead, the intent with the removable cooling die flow guide is that it can be added or removed with minimal tools, in a short space of time, reducing production down time and increasing the variety of products a single cooling die can produce.

### SUMMARY AND FIGURES

An invention is set out in the independent claims, and optional features are set out in the dependent claims.

The present invention will now be described, by way of example only, with reference to the accompanying drawings.

FIG. 1 shows a cross sectional view of a high moisture extrusion apparatus and cooling die.

FIG. 2a shows an isometric view of a cooling die and retractable guide, where the retractable guide is removed from the cooling die. FIG. 2b shows a front view of the cooling die and retractable guide.

FIG. 3 shows an isometric view of a cooling die and retractable guide, where the retractable guide is inserted into the cooling die.

FIGS. 4a, 4b and 4c each respectively show a front view, plan view and side view of the retractable guide inserted into the cooling die.

FIGS. 5a, 5b and 5c each respectively show an isometric view, front view, plan view and side view of the retractable guide inserted into a square shape cooling die.

FIG. 6a shows an isometric view a first embodiment of the removable flow guide with attachment points to cooling die. FIG. 6b shows a front view of the attachment point and surface of the cooling die.

FIGS. 7a and 7b show exploded views of the first embodiment of the output end of the cooling die and the fixings of the retractable guide to the cooling die. FIG. 7c shows an exploded view of the extruder end of the cooling die and fixings of the retractable guide to the cooing die.

FIG. 8a shows a second embodiment of the retractable guide. FIGS. 8b and 8c show the output and extruder ends of the second embodiment.

FIG. 9a shows the output end of the second embodiment of the retractable guide. FIG. 9b shows the first end of the second embodiment of the retractable guide.

FIGS. 10a and 10b respectively show the output end and extruder end of the cooling die shown with multiple retractable guides.

FIGS. 11a, 11b, 11c and 11d show the respective isometric, bottom, top and side view of a third embodiment of the retractable guide, including a flow-splitter.

FIGS. 12a, 12b and 12c respectively show the first end, central section and second end of a fourth embodiment of the retractable guide, including integrated cooling.

FIGS. 13a and 13b show respectively an exploded view and non-exploded view of the second end of the further embodiment of the retractable guide.

FIGS. 14a and 14b show respectively a non-exploded view and exploded view of the second end of the fourth embodiment of the retractable guide.

FIGS. 15a shows the expected speed profile for an example cylindrical cooling die without a retractable guide. FIGS. 15b and 12c show respectively the actual speed profile for an example cylindrical cooling die without and with the retractable guide inserted into the cooling die.

### DETAILED DESCRIPTION

The present disclosure will now be described by way of example only. These are not the only ways that the disclosure may be put into practise.

By way of background, as is well known, extrusion is a continuous mixing, kneading, and shaping process used to produce a desired product. Food extrusion is not new to the food industry and has been utilized to produce many different types of food products for more than 60 years. Well known extrusion applications in the food industry include pasta, breakfast cereals, baby food, pet food, and other confectionery products. Almost all of these applications take place at low to intermediate level moisture contents (for a water weight of less than 40%).

High moisture extrusion is a relatively new type of extrusion. High moisture extrusion cooking describes a process that allows the formation of strands or larger pieces from protein rich powders, slurries or small pieces such as plant proteins, meat and fish. High-moisture extrusion cooking of plant proteins has recently gained increasing attention for producing meat alternatives. The combination of heating and subsequent cooling of the protein—water mixture facilitates the texturization of the product and produces a layered or fibrous structure with a ‘meat like’ appearance. High moisture extrusion is characterised by processing materials with a high water content, compared to traditional extrusion methods. Typically, the materials used in high moisture extrusion have a water weight higher than 40% and often higher than 50%. Due to the unusually high water content in the processed materials and due to the elevated temperature needed to produce the desired effect, the viscosity of the material in the extruder is relatively low (i.e. a creamy, purée like texture). The viscosity and high temperature means that the under typical processing conditions the mixing of materials within the extruder barrel is very effective. Counterintuitively this can adversely affect for example the appearance of conventionally marbled products. Often, high moisture extrusion is therefore combined with a twin screw extruder for making unconventional food products.

The high moisture extrusion process can be affected by several independent process variables such as raw material characteristics, the high moisture extrusion apparatus and process design on the formation of fibrous structures. Concurrently, the effects of dependent system parameters such as pressure, temperature, and changes at a molecular level with focus on protein—protein interactions can also significantly affect the extruded product. In particular, the process is sensitive to a combination of temperature profile in the extruder, the exposed temperature of the injected products, the selected place of injection, the screw profile of the extruder, quantity and composition of the injected liquid as well as frequency of the injection. These factors are all considered in this application.

### Apparatus for High Moisture Extrusion

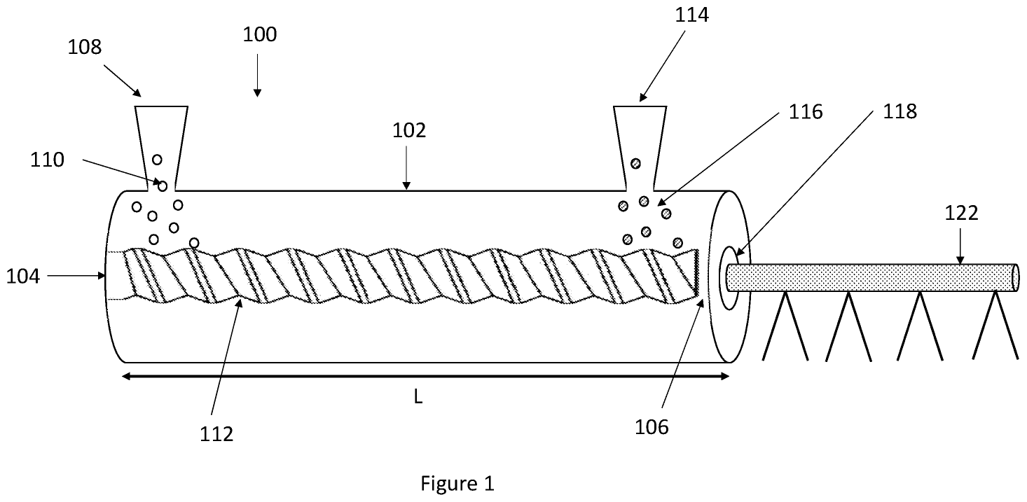

Referring to FIG. 1, a high moisture extrusion apparatus 100 is shown that is suitable for manufacturing foodstuffs. The high moisture extrusion apparatus 100 comprises an extruder barrel 102. The extruder barrel 102 may take various shapes, for example a cylindrical or cuboid shape. The extruder barrel 102 could be formed of metal, the most common type of metal used are nitriding steels, powder metallurgy steels, or bi-metals which are composed by two separates parts: a support base material and an internal lining. The extruder barrel 102 may be a heated extruder barrel. A heated extruder barrel 102 is used to ensure the materials inside the extruder barrel 102 are at the ideal temperature needed to form protein strand structures suitable for consumption. The heated extruder barrel 102 could have a heated exterior dissipating heat into the interior of the extruder barrel 102.

The extruder barrel 102 comprises an inlet port 108 and an outlet port 118. The extruder barrel 102 has an inlet end 104 at or near which the inlet port 108 is located and an outlet end 106 at or near which the outlet port 118 is located. The inlet port 108 and the outlet port 118 could be located at opposing ends of the extruder barrel 102 or respectively downstream and upstream thereof. The extruder barrel 102 further comprises an injection port 114.

The extruder barrel 102 may comprise more than one inlet port 108. For example, the inlet port 108 may comprise a first inlet port, a second inlet port and optionally a third inlet port. The first inlet port may be used to input a dry powder mix (e.g. soy), the second inlet port may be used to input water and the third inlet port may be used to input oils into the extruder barrel 102.

The inlet port 108 is for input of a first material 110. The injection port 114 is for input of a second material 116. The outlet port 118 is for output of a combination of the first material 110 and the second material 116 from the extruder barrel 102. The injection port 114 is located intermediate to the inlet port 108 and the outlet port 118. The injection port 114 may be located closer to the outlet port 118 than the inlet port 108. The injection port 114 could be located adjacent to the outlet port 118. The outlet port 118 and injection port 114 could both be located at the outlet end 106 of the barrel.

The first material 110 could comprise protein rich powders, slurries or small pieces such as plant protein or meat and fish. The first material 110 will also comprise a high level of water. The first material 110 has a first weight and typically more than 40% of the total first weight will be water. The water content is needed to ensure the high moisture extrusion process can occur effectively in the extruder barrel 102. The second material 116 could comprise a colourant or flavouring or other nutrients (e.g. vitamins) or combination of colourants, flavourings or nutrients. For example, the second material could comprise organic colouring ingredients, such as plant extracts from red beetroot, saffron, paprika, red radish and/or black carrot. In conventional arrangements, these ingredients do not withstand the high temperatures present in the extruder barrel 102 and fade or turn to unwanted brownish or dark colours. Additionally, the second material 116 may also comprise heat sensitive flavouring compounds, spices and/or vitamins.

As shown in FIG. 1, the high moisture extrusion apparatus may further comprise an impeller 112. The impeller may be a screw or other type of mechanical device rotatable inside the extruder barrel 102. The impeller 112 is located inside the extruder barrel 102. The impeller could comprise a twin screw extruder system. A twin screw extruder system consists of two intermeshing, co-rotating screws. The twin screw extruder system could be mounted on inlet end 104 inside the extruder barrel 102. There are a wide range of twin screw designs, various screw profiles and process functions that may be used depending on the requirements of the extruded product. While co-rotating, intermeshing screws are widely used for low to high viscous materials other types of screw designs such as counter rotating screws or multi-screws (more than two screws) are known as well.

### Cooling Die Assembly

A cooling die assembly 122, in accordance with the invention, for use at the delivery end of a high moisture proteinaceous food extruder, is shown in FIG. 1. The cooling die 122 is typically attached to the outlet port 118, however, it can also be situated further downstream from the outlet port 118. The cooling die 122 can be used in the high moisture extrusion apparatus used to regulate the temperature and shape of the extruded product. The cooling die 122 stabilises the flow coming out of the extruder barrel and can also be shaped to form the combined first material and second material into a desirable product. Therefore, the cooling die 122 may be formed into various shapes and have various lengths depending on the desired product. The high moisture levels in the high moisture extrusion apparatus 100 combined with elevated temperatures in the extruder barrel 102 may produce a material that is very soft and not self-supporting. The cooling die 122 is specially designed to provide cooling to increase the viscosity of the hot extrudate before exiting, contributing to the correct elasticity and fluidity required for texturization. By cooling the extrudate product the water content in the product is also cooled, this prevents the water from boiling and producing an undesirable texture that is not suitable for meat alternatives. The cooling die 122 may be a rectangular, cylindrical or annular cooling die.

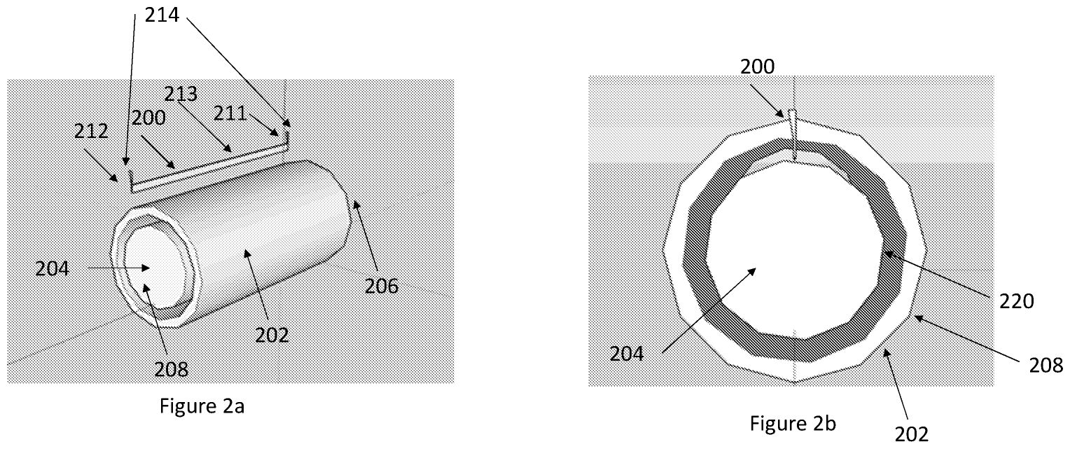

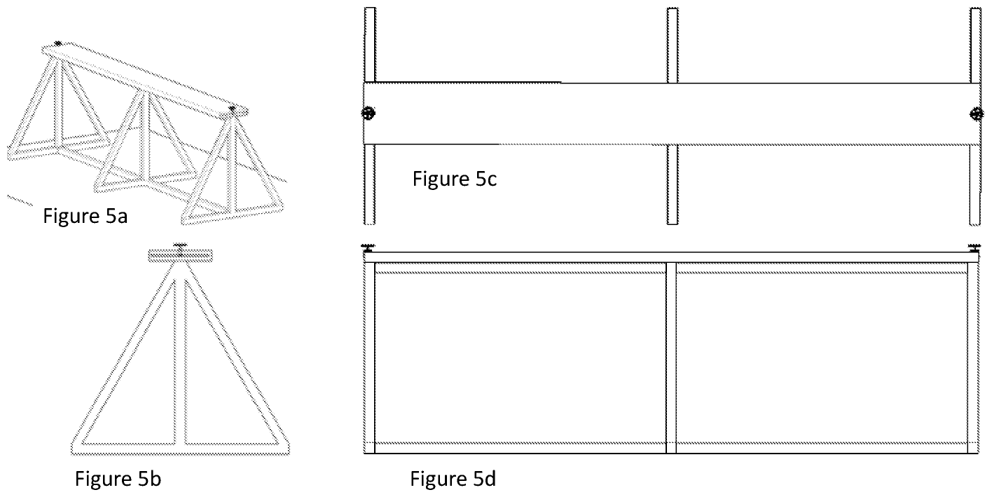

FIG. 2a shows a cooling die 202 and retractable guide 200, and the retractable guide 200 is removed from the cooling die 202. FIG. 2b shows a front view (i.e. the output end) of the cooling die 202 and retractable guide 200, in FIG. 2b the retractable guide 200 is inserted from the cooling die 202. The cooling die shown in FIGS. 2a and 2b is a cylindrical cooling die, however, it could also be a rectangular or annual cooling die. An example of the retractable guide 202 used in a rectangular cooling die is shown in FIGS. 5a-5d for comparison. In this instance, all the same features and capabilities apply as described for the cylindrical die.

As shown in FIG. 2, the cooling die 202 may include an inner portion 204 positioned within the cooling die 202 and extending at least part of the length of the cooling die 202. The dark grey portion shown in FIG. 2b is the extruded product 220 passing through the cooling die 202.

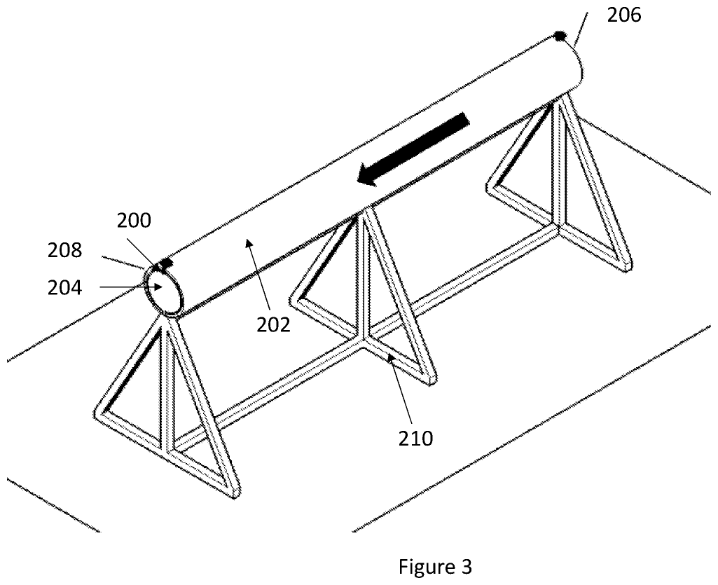

FIG. 3 shows an isometric view of the cooling die and retractable guide shown in FIGS. 2a and 2b. As shown in FIG. 3, the cooling die has an extrudate end 206, into which the extruded product flows from the extruder barrel into the cooling die 202. The cooling die 202 also has an output end 208, from which the extruded and cooled product leaves the cooling die 202 after having passed the through the length of the cooling die 202. The retractable guide 200 is located internal to the cooling die 202 between the output end 208 and the extrudate end 206. The retractable guide 200 may extend the whole length of the cooling die 202 or alternatively may extend only a partial distance between the extrudate end 206 and the output end 208. The direction of flow of the extrudate product is shown by the arrow in FIG. 3. The cooling die 202 is held upwards by a support structure 210 to stabilize the cooling die and ensure that the cooling die is held at the same height as the output channel of the extruder barrel. This ensures that the extruded product has a smooth transition from the extruder barrel to the cooling die.

The retractable guide 200 shown in the figures is rectangular in shape, however the retractable guide 200 can also feasibly be any possible shape that fits within the cavity of the cooling die 202. The retractable guide has a first end 211, a second end 212 and an intermediate portion 213 (see FIG. 2a). The retractable guide 200 has a length that extends from the first end 211 to the second end 212 of the retractable guide 200. The retractable guide 200 also has two protruding end portions 214 located at both the first end 211 and second end 212 of the retractable guide 200. The protruding end portions 214 protrude upwards and away from the retractable guide 200 and are used to secure the retractable guide 200 to the cooling die 202. In FIGS. 2a and 2b, the protruding end portions 214 are not located within the cavity of the cooling die, instead they protrude outwards from either end of the cooling die and may be affixed to the ends of the cooling die.

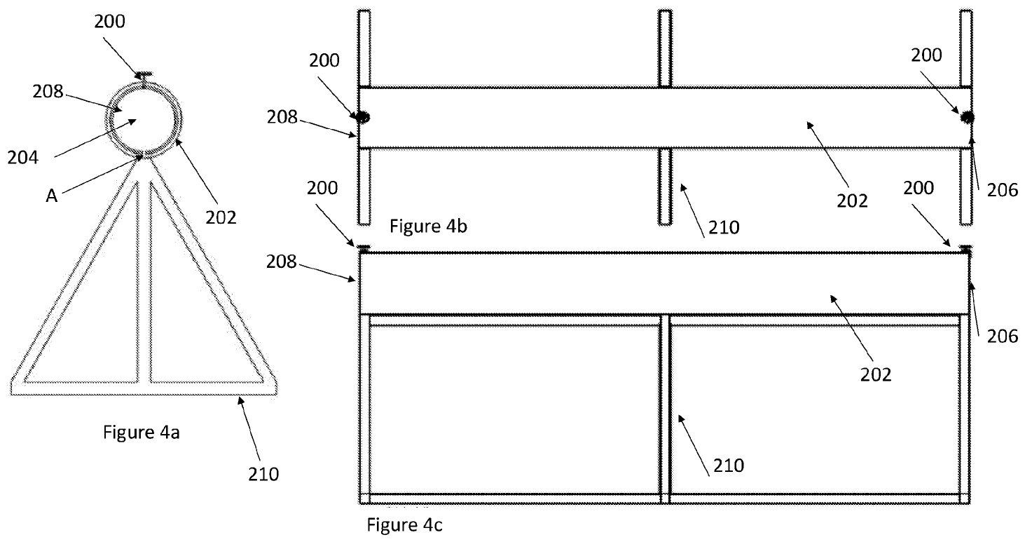

The retractable guide 200 shown in FIGS. 2, 3 and 4a-c is positioned at the top of the cooling die 202, however, it is feasible that the retractable guide may be located anywhere within the cavity of the cooling die 202. In particular, the retractable guide may be located at the top, bottom, left or right of the cooling die 202. FIGS. 4a-c shows respectively the front view, plan view and side view of the cooling die 202 with the retractable guide 200 inserted into the cooling die 202. In the example shown in FIGS. 2, 3 and 4a-c the retractable guide 200 extends the whole length of the cooling die 202.

The retractable guide 200 has a locked position, in which it is secured between an input end and an output end of the cooling die; and an unlocked position, in which it is retractable from the cooling die. The locked and unlocked position can be achieved though a variety of different locking mechanisms, some examples of which are described.

The first end 211 of the retractable guide 200 is attached to the extrudate end 206 of the cooling die 202. This attachment can be via a first fixing. The second end 212 of the retractable guide 200 is attached to the output end 208 of the cooling die 202. This can be via a second fixing. The first and second fixing may correspond to the protruding end portions 214. The first and second fixings can be located externally to the cavity of the cooling die, for example on the extrudate end 206 and on the output end 208. They can also be located on the outer surface of the cooling die. Alternatively, the first and second fixings can be located internally within the cavity of the cooling die (not shown).

### General Description of Fixing Mechanisms

Using the first and second fixings, the retractable guide 200 is held securely in position within the cavity of the cooling die 202. The first and second fixings can be held in either a locked position, when the retractable guide is fixed to the cooling die 202, or an unlocked position, when the retractable guide 200 is free to be removed from the cooling die. The retractable guide 200 can be removed from the cooling die 202 by setting the first and second fixings to the unlocked positions and sliding the retractable guide 200 down the length of the cavity of the cooling die 202. Similarly, the retractable guide 200 may be inserted into the cooling die 202 by pushing the retractable guide down the length of the cavity of the cooling die 202, positioning the first and second fixings and setting the first and second fixings to the locked position. The retractable guide 200 is reusable can be continually removed and inserted into the cooling die 202. In this way, it is possible to reconfigure the cooling die 202 quickly and easily as the retractable guide 200 can be removed and inserted quickly and efficiently. The retractable guide 200 can also be replaced with different types of retractable guides (e.g. different shape, texture) to create a cooling die channel with different characteristics.

The retractable guide 200 must fit within the cavity of the cooling die 202 between the surface of the cooling die 202 and the inner portion 204. The retractable guide 200 can be added or removed from the cooling die 202 with minimal tools, in a short space of time. The retractable guide 200 produces shear edge effects on the extrudate product as it passes through the cooling die 202. A frictional force between the surface of the retractable guide 200 and the extruded product causes a more fibrous product to be output from the cooling die 202.

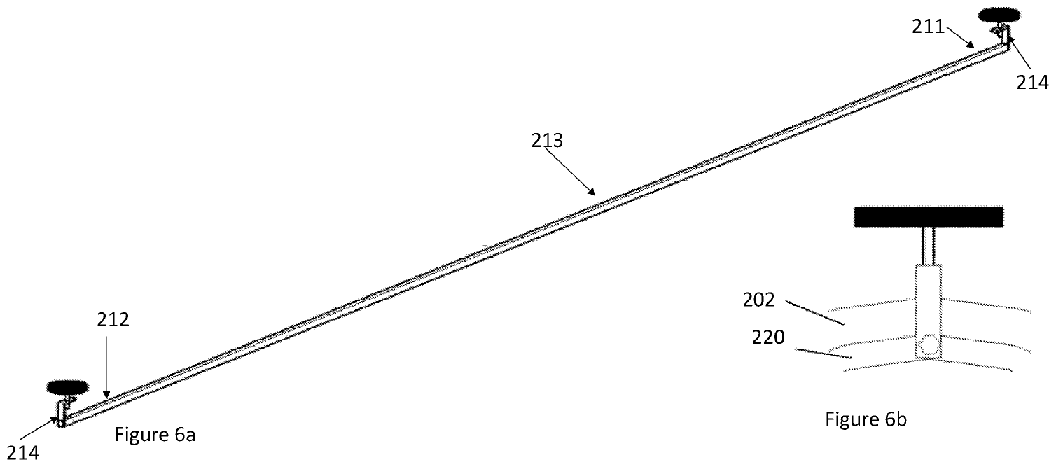

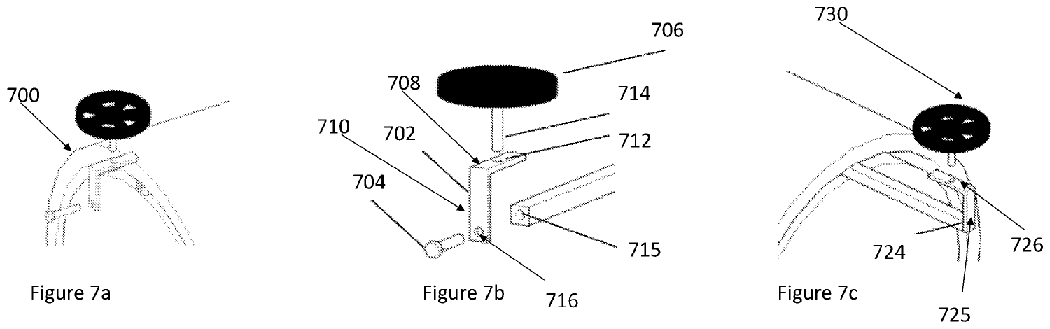

FIGS. 6 and 7 shows one possible example of the first and second fixings. The example of the fixing shown in FIGS. 7a and 7b could be applied to both ends of the retractable guide. In this way, both the first and second fixings are identical and therefore the first end 211 and second end 212 are interchangeable and the retractable guide may be inserted either way into the cooling die 202.

An exploded view of the fixing 700 is shown in FIGS. 7a and 7b. The fixing 700 is made up of a fixing plate 702, a mechanical fastener 704 and a manual handle 706. The fixing plate 702 is ‘L-shaped’ and is made from a first section 708 and second section 710, the first 708 and second 710 section being positioned perpendicularly to each other. The first section 708 and the second section 710 could be welded together or machined from a single piece of metal. In this way the first section 708 and second section 710 are joined together to ensure a strong fixing plate 702. The first section 708 has a threaded hole 712. A threaded rod 714 of the manual handle 706 is positioned through the threaded hole 712 of the first section 708 and is used to secure the first section of the fixing plate 702 to the cooling die 202. In this way, first section can be secured to the top of the cooling die. The manual handle 706 can be rotated to tighten the fixing of the first section 708 of the fixing plate 702 to the cooling die 202. Similarly, the manual handle 706 can be rotated in the opposite direction to loosen the fixing of the first section 708 of the fixing plate 702 to the cooling die 202. The second section 710 of the fixing plate 702 also has a hole 716. The mechanical fastener 704 (e.g. bolt or screw) passes through the hole 716 and secures the second section 710 of the fixing plate 702 to one end 715 of the retractable guide (by passing through and securing to another threaded hole).

Instead of both ends of the guides having the same fixing as shown in FIGS. 7a and 7b, either the first end 211 or the second end 212 of the retractable guide 200 could have the configuration shown in FIG. 7c. For example, the first end 211 could have the welded joint 724 shown in FIG. 7c and the second end 212 could have the fixing as shown in FIGS. 7a and 7b (or vice versa). FIG. 7c shows a fixing plate 725 permanently fixed to one end of the retractable guide 200 via the welded joint 724. The retractable guide 200 can be inserted into the cooling die 202 by pushing the end with the permanently fixed welded joint 724 into the cooling die until the exits the other end and then hooking the I shape' plate around the end of the cooling die 202 and securing to the outer surface of the cooling die using a mechanical handle 730. The mechanical handle works the same way as the mechanical handle as discussed previously (with respect to FIGS. 7a and 7b) by positioning through a threaded hole 726 of the fixing plate 725. As an alternative option, the retractable guide 200 can be inserted into the cooling die 202 by pushing the end of the retractable guide 200 with no fixing through the cooling die 202 and then securing the fixing plate 702, a mechanical fastener 704 and a manual handle 706 together (as shown in FIG. 7b). At the other end of the cooling die 202 the hooking the ‘L shape’ plate of the welded joint 724 is hooked around the end of the cooling die 202 and secured in the same manor a previously explained. The second of these options for inserting the retractable guide 200 into the cooling die 202 is preferable as it is easier to pass the retractable guide 200 through the cooling die 202 without the presence of any permanently fixed joints.

The configurations shown in FIGS. 6 and 7 can be assembled, disassembled and reassembled again to move between the locked and unlocked positions, thereby allowing the retractable guide 200 to be inserted and removed from the cooling die 202.

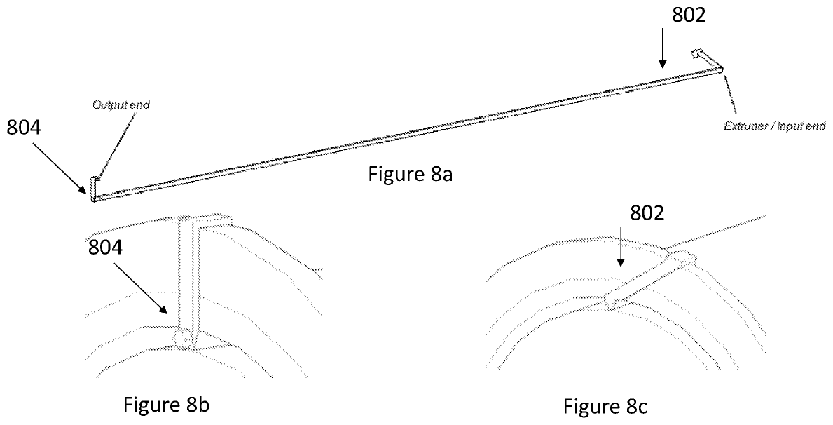

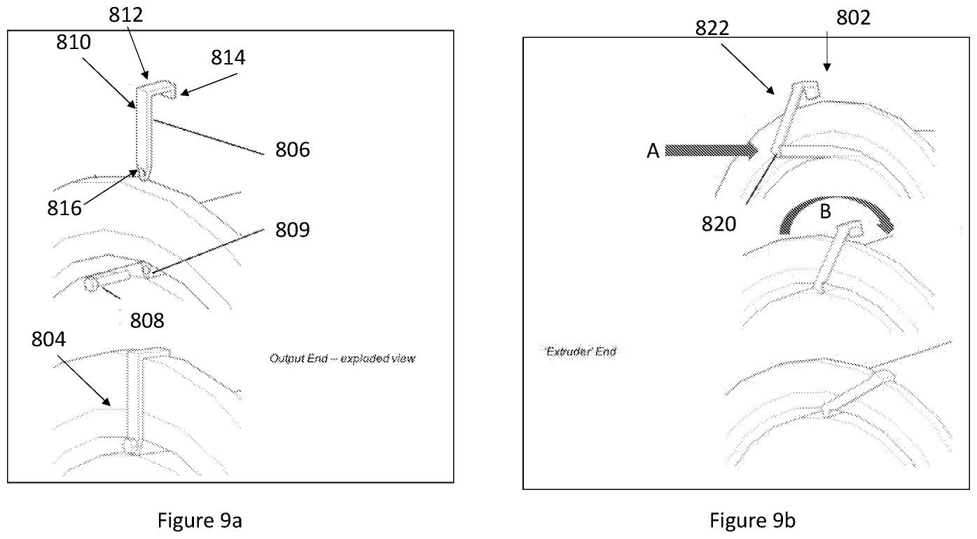

FIGS. 8 and 9 show an alternative example of the first and second fixings. FIG. 8a shows the retractable guide 200 including a primary fixing 802 at the first end of the retractable guide and a secondary fixing 804 at the second end of the retractable guide.

The primary fixing 802 comprises a fixing element 822 that is secured to the retractable guide via a welded joint 820, as shown in FIGS. 8c and 9b. The welded joint 820 prevents any obstruction to the flow of the extruded product. The primary fixing 802 is formed as one whole piece and is placed in contact with the extruder end of the cooling die and a flange hooks around the cooling of the extruder end of the cooling die and secured the primary fixing 802 in position.

FIGS. 8b and 9a shows the composition of the secondary fixing used at the second end of the retractable guide. The secondary fixing 804 is made up of a fixing plate 806 and mechanical fastener 808. The fixing plate 806 is made from a first section 810, second section 812 and flange 814. The first section 810 and second section 812 are positioned perpendicularly to each other. The first section 810 has a hole 816. The mechanical fastener 808 is positioned through the hole 816 of the first section 810 and is used to secure the first section 810 of the fixing plate 806 to the retractable guide, as shown in FIG. 9a. In this way, first section 810 can be secured to the retractable guide (by passing through and securing to another threaded hole in the retractable guide 200). The second section 812 of the fixing plate 806 is placed in contact with the collar of the cooling die at the output end of the cooling die. The flange 814 hooks around the collar of the cooling die and secures the secondary fixing 804.

The fixing plate 806 shown in FIG. 8b is held in place completely by the mechanical fastener 808 and is hence fully detachable and reassemble. As shown in FIG. 9a the retractable guide 200 may have a tapered cross section 809 at the second end of the retractable guide 200.

The retractable guide 200 is inserted into the cooling die 202 at the extruder end 206(as shown by the arrow A in FIG. 9b). The retractable guide 202 is ‘pushed’ into the extruder end 206 of the cooling die 202 until the primary fixing 802 comes into contact with the extruder end 206 of the cooling die 202. The primary fixing is then locked into position and secured to the extruder end of the cooling die by rotating the retractable guide 200 (as shown by the arrow B in FIG. 9b). By rotating the retractable guide 200 it is locked into place and any radial movement of the retractable guide 200 is prevented. This prevents any obstruction to the flow of extrudate which would be presented by a mechanical fastener. After the primary fixing is 802 secured into place, the secondary fixing 804 is then secured by inserting the mechanical fastener 808 into the hole 816 and securing to the retractable guide 200.

The secondary fixing 804 can be assembled, disassembled and reassembled again to move between the locked and unlocked positions, thereby allowing the retractable guide 200 to be inserted and removed from the cooling die 202.

### Multiple Flow Guides

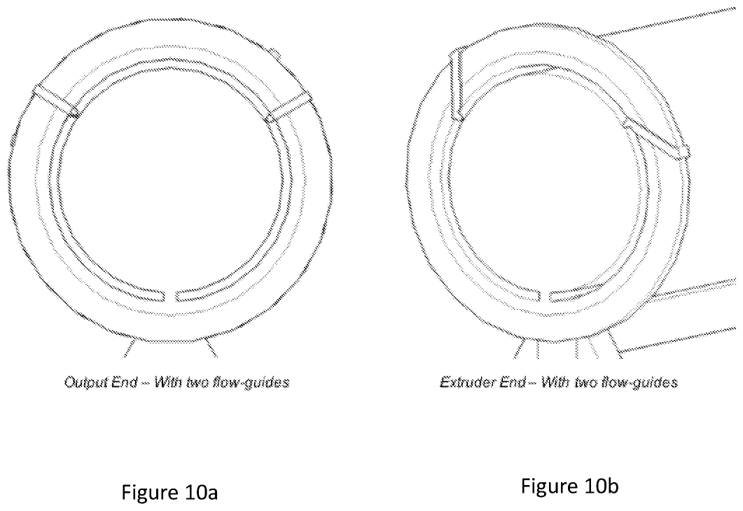

FIGS. 10a and 10b show the cooling die 202 and two retractable guides 200. It is possible for the cooling die 202 to incorporate two or more retractable guides 200. The fixings of the retractable guides 200 can be either of the examples previously discussed. Each retractable guide can have a different fixing, such that the cooling die 202 contains retractable guides 200 with different types of fixings.

Multiple retractable guides 200 can be used to vary the output of the extruded product. In particular, by increasing the amount of extruded product that comes into contact with a retractable guide there is an increased frictional resistance and therefore the output product can be produced with a more fibrous structure. The fibrous structure can also be delivered to a greater volume of extruded product within a smaller timeframe. The multiple flow guides can also be used to split the flow into different ‘slabs’ of extruded product. The greater the number of retractable guides the greater the number of ‘slabs’ that may be produced.

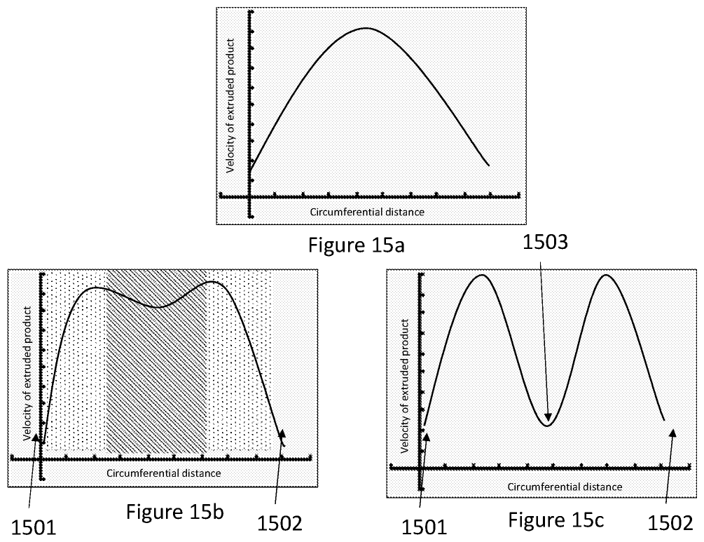

Multiple retractable guides 200 can be distributed radially around the cylindrical die at equal spacings or laterally across a cooling die with a rectangular cross section. Similarly, the spacing of retractable guides 200 can be modified depending on the desired parabolic flow speed profile of the extruded product (see FIGS. 15b and 15c).

### Flow Splitter

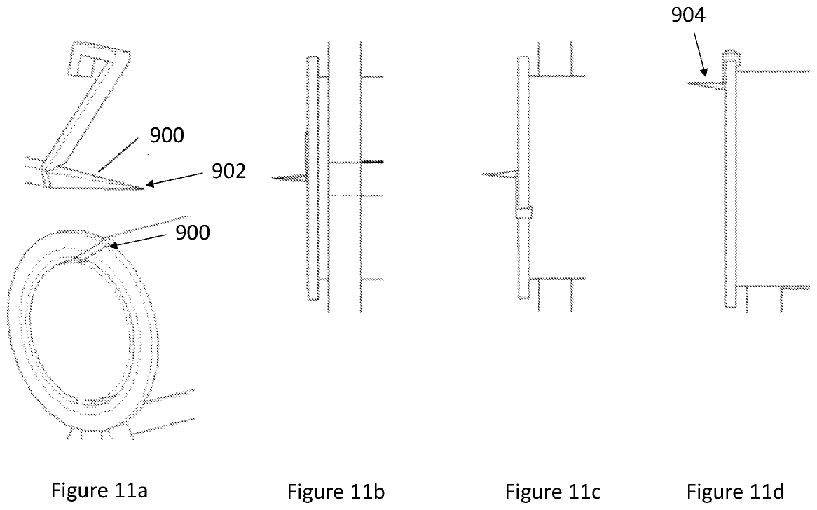

As an optional feature a flow splitter 900 can be applied to the first end 211 of the retractable guide (i.e. where the extruder barrel connects to the cooling die). An example of a flow splitter 900 is shown in FIGS. 11a-11d. The flow splitter 900 is connected to the end of the retractable guide 200 and extends parallel to the retractable guide 200. The flow splitter 900 protrudes outwards from the retractable guide 200. The flow splitter 900 shown in FIG. 11 has a triangular pyramid shape that tapers to a sharp point 902 at the point of the flow splitter that is furthest from the retractable guide 200. The flow splitter 900 also has a flat top 904 such that it follows the same line as the rectangular shaped retractable guide. It is possible for the flow splitter 900 to be fashioned into any desirable shape to best suit the application, for example depending on the composition of the extruded product and desired end product.

The purpose of the flow splitter 900 is to reduce the friction and pressure as the extruded product flows from the extruder barrel to the cooling die 202. This therefore reduces the pressure at the connection point between the extruder barrel and the cooling die 202 and allows for a smooth transition of the extruded product. This also reduces blockages and leakages of extruded product at the connection point. Therefore, the flow splitter 900 mitigates any disadvantages of using the retractable guide 200 (such as interruption of flow caused at the connection point of the extruder barrel and cooling die 202).

The sharp point 902 is designed to minimise the pressure on the retractable guide and facilitate transfer of extruded product.

### Integrated Cooling

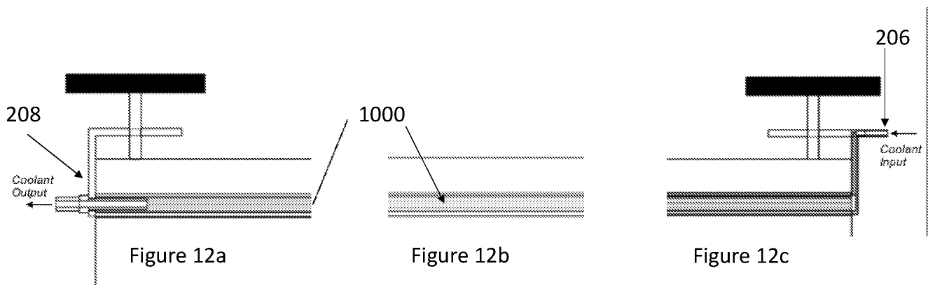

The retractable guide 200 may also include an integrated cooling system as shown in FIGS. 12 to 14. The integrated cooling system comprises a central cooling channel 1000 that runs through the entirety of the retractable guide 200, extending from the first end 206 (where coolant is input, see FIG. 12a), passing through the central section and then output at the second end 208 (where coolant is output, see FIG. 12c). The fixings at both ends of the retractable guide have been adjusted to accommodate the cooling channel 1000. For example, the mechanical fastener has been extended to allow a hose or water pipe to be fastened to it and a hollow core has been created to allow coolant to pass through.

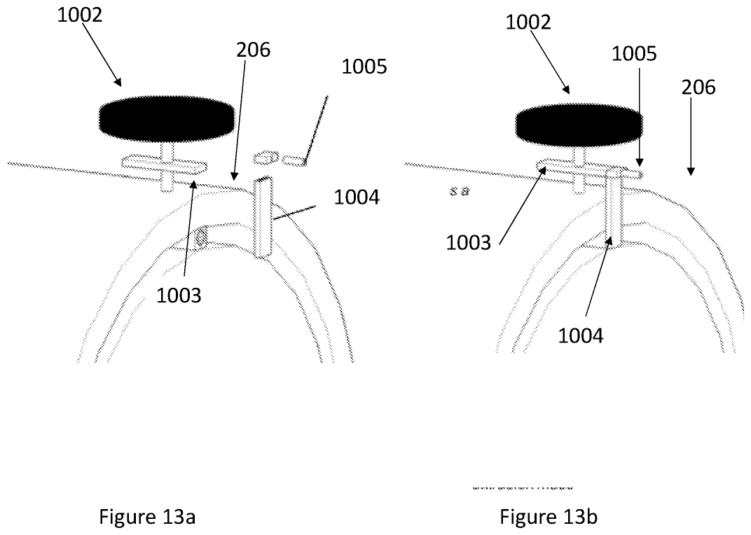

FIGS. 13a and 13b show in greater detail the first end 211 of the retractable guide 200 and show how the fixing described in FIGS. 6 and 7 can be adjusted to accommodate the cooling channel 1000. The fixing plate is adjusted such that the vertical section 1004 both have hollow cores that allow coolant to pass through. At the connection point between the vertical section 1004 and horizontal section 1004 there is a cylindrical connection piece 1005 that connects the coolant supply (e.g. water pipe) to the retractable guide. Water is then pumped into the cylindrical connection piece 1005, down the vertical section 1004 and into the retractable guide 200. Otherwise all other features of the fixing are the same as described relation to FIGS. 6 and 7.

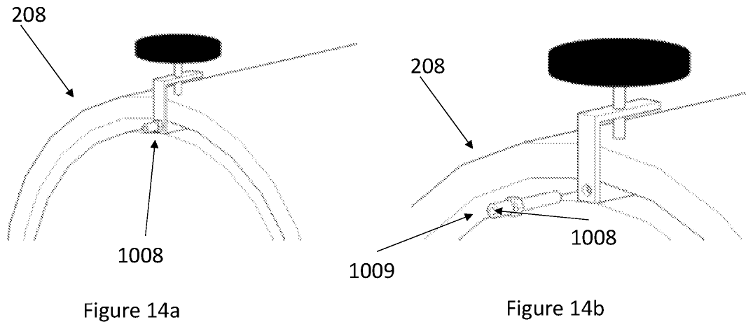

FIGS. 14a and 14b show in greater detail the second end 208 of the retractable guide 200 and show how the fixing described in FIGS. 6 and 7 can be adjusted to accommodate the cooling channel 1000. The mechanical fastener 1008 shown in FIGS. 14a and 14b is adjusted to accommodate a channel (see the opening hole 1009) for the coolant to pass through and exit from.

### Advantages of the Invention

The retractable flow guide 200 creates a simple but effective way to be able to guide the flow of material through a cooling die 202, without needing to fundamentally or permanently alter the cooling die itself. This has the advantage that it can be applied to cooling die if required and then removed if no longer desirable. The changing of the properties of the cooling die can therefore be optimised to produce peak performance. The changing of the properties of the cooling die can also be conducted in a much shorter time span than it would take to weld various channels for instance. Instead, the intent with the removable guide is that it can be added or removed with minimal tools, in a short space of time, reducing production down time and increasing the variety of products a single cooling die can produce.

The retractable guide 200 produces shear edge effects on the extrudate product as it passes through the cooling die 202. A frictional force between the surface of the retractable guide 200 and the extruded product causes a more fibrous product to be output from the cooling die 202.

Speed profiles of the extruded product are shown in FIGS. 15a, 15b and 15c (for example for the cooling die profile shown in FIG. 4a). The expected speed profile of the extruded product without the retractable guide is shown in FIGS. 15a. However, in reality the extruded product actually exhibits a surprisingly different profile. FIG. 15b shows the actual speed profile for the cylindrical cooling die without the retractable guide 200 inserted.

In FIG. 15b, the positions labelled 1501 and 1502 are where the extruded product interacts with the surface of the cooling die (for example the position labelled ‘A’ in FIG. 4a). The extruded product travels more slowly when in contact with the surface of the cooling die due to frictional shear edge effects. It is desirable to replicate more frictional effects by using at least one retractable guide.

The zone highlighted by the ‘spotted texture’ in FIG. 15b represents the greatest shear in the flow caused by different flow speeds due to the frictional force of the side of the cooling die. This area is where the best fibre formation is witnessed. The zone highlighted by the ‘zigazg stripe texture’ in FIG. 15b represents the area of the flow where there is very little variation in flow speed. This resulted in low fibre formation. There is a surprising effect shown in the very middle of the circumferential distance where the flow actually slows down and then speeds up again.

The retractable guide 200 is inserted at the position where the flow unexpectedly slows down. Therefore. this maximizes the shear forces experienced at this position. This position is chosen as it leads to better fibre formation throughout the extruded product. FIG. 15c shows the speed profile for the cylindrical cooling die with the retractable guide 200 inserted. In this instance, the position labelled 1503 is where the retractable guide is positioned. The retractable guide 200 has the effect of increasing frictional shear edge effects in the middle portion of the extrudate product. Similarly, further retractable guides 200 can be inserted into the cooling die to enhance this effect.

This leads to the production of a foodstuff product that is more fibrous in texture and therefore allows the composition of meat and fish to be created in a meat alternative product. The end result is a more ‘meat-like’ food product.

The flow guide does not need to be the full width of the channel, and different material properties can be obtained by varying the proportion of the channel is blocked off. Similarly, different segments of the removable guide may be made from different thicknesses.

The retractable guide 200 can have a cross-sectional profile that varies along the length of the retractable guide 200. This can be useful to vary the amount of surface friction received by the extrudate product at different positions in the cooling die 202. The retractable guide 200 can have a first cross-sectional profile at a first end 211 of the retractable guide 200 and a second cross-sectional profile at a second end 212 of the retractable guide 200 and the first and second cross-sectional profiles can be different. Alternatively, modelling techniques may be used to understand the most desirable cross-sectional profile of the cooling die and these profiles can be applied to the retractable guide 200. For example, the retractable guide 200 may have a square shaped cross sectional profile at the first end 211 and a triangular shaped cross-sectional profile at the second end 212. Other possible shaped cross-sectional profiles will also be considered depending on the shape of the cooling die and desired output characteristics of the extruded product.

Similarly, the same techniques can be applied to surface roughness and texture to vary the amount of frictional force imparted to the extruded product at different positions in the cooling die 202. The retractable guide 200 can have a surface roughness that varies along the length of the retractable guide 200. The retractable guide 200 has first surface roughness at a first end 211 of the retractable guide and a second surface roughness at a second end 212 of the retractable guide 200, and the first and second surface roughness's can be different.

The material could be flexible to encourage a radial flow, the surface roughness can be adapted to increase or decrease the fibre formation resulting from shear effects on the flow or multiple guides could be used to significantly increase the shear effect imparted onto the product flow.

1. A retractable guide for use in a cooling die for the manufacture of extruded food products;
wherein the retractable guide is configured to be secured between an input end and an output end of the cooling die.

2. The retractable guide of claim 1, wherein the retractable guide has a locked position, in which it is secured between an input end and an output end of the cooling die;
and an unlocked position, in which it is retractable from the cooling die.

3. The retractable guide of claim 1, wherein the retractable guide has a first end, a second end and an intermediate portion, and the first end of the retractable guide is configured to be attached to an extrudate end of the cooling die and the second end of the retractable guide is configured to be attached an output end of the cooling die.

4. The retractable guide of claim wherein the first end of the retractable guide is secured to the extrudate end of the cooling die via a first fixing and the second end of the retractable guide is secured to the output end of the cooling die via a second fixing.

5. The retractable guide of claim 1 wherein the retractable guide is the same length as the cooling die.

6. The retractable guide of claim 1 further comprising a flow splitter attached to a first end of the retractable guide.

7. The retractable guide of claim 1 wherein the retractable guide further comprises an integrated cooling channel.

8. The retractable guide of claim 1 wherein the retractable guide has a cross-sectional profile that varies along the length of the retractable guide.

9. The retractable guide of claim 1 wherein the retractable guide has a first cross-sectional profile at a first end of the retractable guide and a second cross-sectional profile at a second end of the retractable guide, wherein the first and second cross-sectional profiles are different.

10. The retractable guide of claim 1 wherein the retractable guide has a surface roughness that varies along the length of the retractable guide.

11. The retractable guide of claim 1 wherein the retractable guide has a first surface roughness at a first end of the retractable guide and a second surface roughness at a second end of the retractable guide, wherein the roughness of the first surface roughness and the second surface roughness are different.

12. A cooling die for use in the manufacture of extruded food products comprising the retractable guide of claim 1.

13. A high moisture extrusion apparatus for use in the manufacture of extruded food products, comprising:
a cooling die, wherein the cooling die further comprises a retractable guide for use in the cooling die;
wherein the retractable guide is configured to be secured between an input end and an output end of the cooling die.

14. The cooling die of claim 12, comprising more than one retractable guide.

15. A method of high moisture extrusion suitable for manufacturing foodstuffs, comprising the steps of:
inserting the retractable guide of claim 1 into a cooling die;
outputting a material from an extruder barrel and inserting the material into a cooling die;
passing the material through the cooling die; and
outputting the material from the cooling die.

16. A foodstuff product obtained by the process of high moisture extrusion of claim 15.

17. The high moisture extrusion apparatus of claim 13, comprising more than one retractable guide.
